(19) United States
(12) Patent Application Publication
(10) Pub. No.: US 2009/0323923 A1
(43) Pub. Date: Dec. 31, 2009

(54) CONTROLLER USING DUAL-TONE MULTI-FREQUENCY (DTMF) TONES

(75) Inventor: Richard Frey, Louisville, CO (US)

Correspondence Address: SHERIDAN ROSS PC, 1560 BROADWAY, SUITE 1200, DENVER, CO, 80202, US

(73) Assignee: VIDEO ACCESSORY CORPORATION, Boulder, CO (US)

(21) Appl. No.: 11/696,056

(22) Filed: Apr. 3, 2007

Related U.S. Application Data
(60) Provisional application No. 60/745,507, filed on Apr. 24, 2006.

(51) Int. Cl. H04M 3/00

(52) U.S. Cl. 379/386

(57) ABSTRACT

A method and device for converting signals from a Human-Interface Device or similar input device to a stream of digital signals that are useable as inputs to an RS-232 or dual-tone multi-frequency (DTMF) circuit is provided. More specifically, the input from the input device may be received at a universal Serial Bus (USB) host and converted to an RS-232 or DTMF signal for ultimate use in controlling a remote device such as a camera in a video security system.

### CROSS REFERENCE TO RELATED APPLICATION

This Application claims the benefit of U.S. Provisional Application No. 60/745,507, filed Apr. 24, 2006, the entire disclosure of which is hereby incorporated herein by reference.

### FIELD OF INVENTION

The present invention relates to the general field of the signal processing. More specifically, the present invention provides mechanisms for converting signals of one data transmission standard to a second data transmission standard, such as from a stream of digital signals to an RS-232 or Dual-Tone Multi-Frequency (DTMF) signal.

### BACKGROUND OF THE INVENTION

Conventional remote security cameras and other remote controlled devices have become an entrenched technology for many industries. Most security cameras are based on old and somewhat outdated technologies. As an example, a member of remote security cameras are controlled by DTMF or RS-232 signals. With reference to FIG. 1, a user interacts with an RS-232 or DTMF controller 104 to transmit control signals to a remote station 108. The transmitted control signals 112 are usually sent as a frequency shift-keyed type signal (e.g. according to DTMF standards), where the frequency of the signal is modulated between predetermined values to represent a certain control signal. The remote control of these functions are particularly useful in surveillance by law enforcement where they may wish to pick up broad field of view and then focus in on suspicious activity with a high-resolution camera.

DTMF signaling is a multi-frequency shift-keying system that was developed by Bell Labs to allow dialing signals to dial long-distance numbers. These tones or frequencies can be used to control the operation of the remote station 108, or more specifically a camera or the like associated with the remote station 108.

The DTMF keypad is laid out in a 4×4 matrix shown in Table 1, with each row representing a low frequency, and each column representing a high frequency. Pressing a single key on a telephone such as “1” will send a sinusoidal tone of the two frequencies 697 and 1209 hertz (Hz), for example. The two transmitted tones are the reason that the term multi-frequency signaling is used. In Plain Old Telephone Systems (POTS), these tones are received and decoded by the switching center in order to determine which key was pressed and thus determine what person is being called.

TABLE 1
DTMF keypad frequencies (with sound clips)

| | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 0 | # | D |

Another controller standard currently used in surveillance technologies is the RS-232 standard. The RS-232-C standard defines 25 circuits that can be used to connect two communicating stations and describes the electrical characteristics of the signals carried over these circuits. CCITT Recommendation V.24 defines these same 25 circuits and Recommendation V.28 defines the electrical characteristics of the signals. The circuits in the RS-232 standards are referred to by circuit number. An RS-232 interface allows for serial transmission speeds up to 20 Kbits/second. The functions to be preformed through this interface are divided into four groups and each circuit is assigned to a specific group. The groups of RS-232 are data, control, timing and ground. It should be noted that the RS-232-C is a physical layer standard and does not define functions at higher levels in a data communications system. The connectors are not specified in the standard; however, the 25-pin connector has become well known in the art and is generally accepted for implementing the RS-232 standard.

The remote station 108 may include a remote controlled camera that is used for surveillance of a certain area. A security guard or other type of security personnel is capable of manipulating various aspects (e.g., zoom, tilt, pan, focus, lighting, etc.) of the camera by sending a DTMF or RS-232 signal to the camera. The signal is typically generated by a phone or radio that is designed to generate DTMF signals. In one example, a security personnel may press the “1” button and the corresponding DTMF control signal 112 is transmitted to the remote station 108. Upon receiving the control signal, the remote station decodes the signal and identifies the two characteristic frequencies associated with the “1.” Thereafter, the decoding circuitry of the remote station 108 generates a signal that manipulates a certain aspect of the camera, such as “zoom in.”

As noted above, the technologies for controlling remote controlled cameras have slowly evolved as DTMF and RS-232 controller technologies have developed. An example of a current DTMF controller 104 is the AXIS 295 by AXIS Communications Corp. An unfortunate down side to current DTMF and RS-232 controller technologies is that the user interface (i.e., a phone or radio) is not easily learned or used by security personnel. In other words, the act of controlling aspects of a camera with the buttons of a radio is not very user friendly. There is a learning curve associated with learning how to control cameras with a radio or other type of DTMF controller. Given the amount of turn-over in the security industry and law enforcement, a significant amount of time is wasted in teaching personnel to properly control cameras and other remote control equipment.

There are newer control technologies that provide a more user-friendly interface. However, these newer technologies require a complete replacement of the remote station 108 as well as the controller 104. Therefore, the cost of updating to a security system that comprises user-friendly input devices can be costly and time consuming.

What is desired is a converter capable of receiving input signals from a user-friendly interface and converting the received signals into signals suitable for use in current DTMF and RS-232 controller technologies.

### SUMMARY OF INVENTION

Embodiments of the present invention use commercially available video gamepads or joysticks as the input device. The electronic signals generated by controlling the joystick or buttons can be converted into signals that can be transmitted to receiving devices that understand RS-232 or DTMF commands. These devices can be connected to an RS-232 or USB connector that in turn is connected to the receiver via wires, coaxial cable, wireless, or other transmission links.

Gamepads and other Human-Interface Devices (HIDs) provide a convenient way to translate hand motions into electronic signals. Most HIDs are designed to transmit data via a Universal Serial Bus (USB) and are most frequently used to play video games. By converting the signals from these devices to signals in a form that can be transmitted as an RS-232 signal or DTMF tones the gamepads becomes usable for a much wider verity of applications. For example video imaging systems are used for a wide variety of applications in security systems. If a single camera is used to image the entrance to a plant or of traffic along a street, it maybe desirable to be able to remotely control focus, magnification, sensitivity, pointing angle of the camera and audio pick up and delivery. A convenient converter system that allows users to operate pan, tilt, zoom and the sensitivity variable illumination with an easy to use input device is highly desirable.

Other operations that are useful to control are selection of a camera from among multiple cameras, a time stamp, audio signal, communications channels and output to one or more VCR/DVR/NVR and monitors. In addition to law enforcement, casinos, building security operators, dock managers, the US Border Patrol, shipping depots, and others have related problems that may be addressed by embodiments of the present invention. The current state of the art is to use joysticks and keyboard buttons to control these functions. At present these interfaces are not as effortless to use as control from a gamepad or other input device designed for ease of use and the control procedures must be learned by the user for each piece of equipment and task.

In accordance with at least some embodiments of the present invention, both wired and wireless HID units or other types of input devices can be used. For example, the electronics may take the signals from the gamepad and convert the signals to RS-232 or DTMF signals that in turn can be used to control the camera characteristics, pointing directions, and audio inputs.

In accordance with one embodiment of the present invention, conversion codes may be uploaded to the converter thereby allowing the converter to change function as new input devices or system requirements are added to the basic device. Providing the ability to upload new conversion codes affords the converter to easily adapt to a number of different input devices and/or remote stations (e.g., cameras, camcorders, phones, robots, walkie-talkies, etc.)

In accordance embodiments of the present invention, a converter is used to convert input from the input device (e.g., an HID) to a DTMF or RS-232 output. These two output protocols permit the input device to be used with current video equipment that can be controlled by one of these standards but not the raw output of the input device. One advantage of such a conversion of control protocols is the capability of using the input device for equipment currently installed in the field, rather than requiring a complete replacement of the field equipment.

Accordingly, a method is provided for converting signals from an input device for use in controlling a remote station. In accordance with one embodiment of the present invention, the method comprises the steps of:

receiving a first signal having a first set of characteristics associated with a first data-encoding scheme;

converting the first signal into a second signal having a second set of characteristics associated with a second data-encoding scheme;

transmitting the second signal to a controller of a communications device; and

decoding the second signal to identify control instructions for the communications device, wherein the controller is adapted to decode signals having the second set of characteristics and not the first set of characteristics.

In accordance with embodiments of the present invention, a signal may be converted from using a data-encoding scheme that is not frequency dependent to using a data-encoding scheme that is frequency dependent. The frequency dependent data-encoding scheme may be either analog or digital depending upon the requirements of the circuitry of the communication device (i.e., remote station) being controlled thereby. In accordance with one embodiment, a digital signal may be converted to an analog signal

As used herein, “data-encoding scheme” and “data-encoding method” is understood to include any type of known signal modulation or mapping format, including those known as a standard in the communications art or as a proprietary method of signal modulation or mapping. Accordingly, the use of the term “standard” herein should not be construed to limit the present invention to only industry standards recognized and defined by a standardization entity.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a diagram depicting a system for controlling a remote station in accordance with embodiments of the prior art;

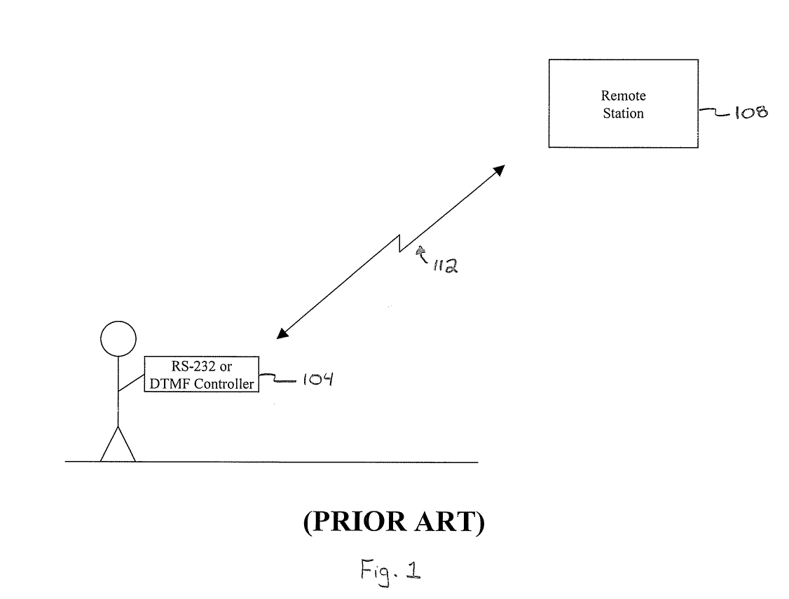

FIG. 2A is a diagram depicting a system for controlling a remote station with an input device and separate converter in accordance with embodiments of the present invention;

FIG. 2B is a diagram depicting a system for controlling a remote station with an input device comprising a converter in accordance with embodiments of the present invention;

FIG. 3 is a block diagram depicting a converter in accordance with embodiments of the present invention;

FIG. 4 is a block diagram depicting the outside of a converter in accordance with embodiments of the present invention;

FIG. 5 is a first view of an exemplary input device used in accordance with embodiments of the present invention;

FIG. 6 is a second view of an exemplary input device used in accordance with embodiments of the present invention;

FIG. 7 is a block diagram depicting a remote station in accordance with embodiments of the present invention; and

FIG. 8 is a flow diagram depicting a method of controlling a remote station with an input device in accordance with embodiments of the present invention.

### DETAILED DESCRIPTION

The exemplary systems, devices, and methods of this invention will be described in relation to a control system. However, to avoid unnecessarily obscuring the present invention, the following description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch or server, a gateway, or communication device, or collocated on a particular node of a distributed network, such as an analog and/or digital communications network.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

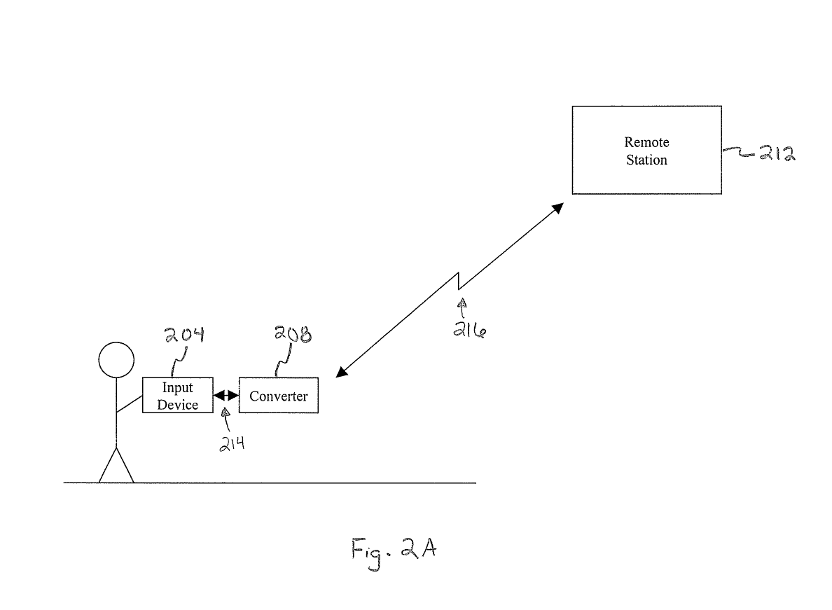

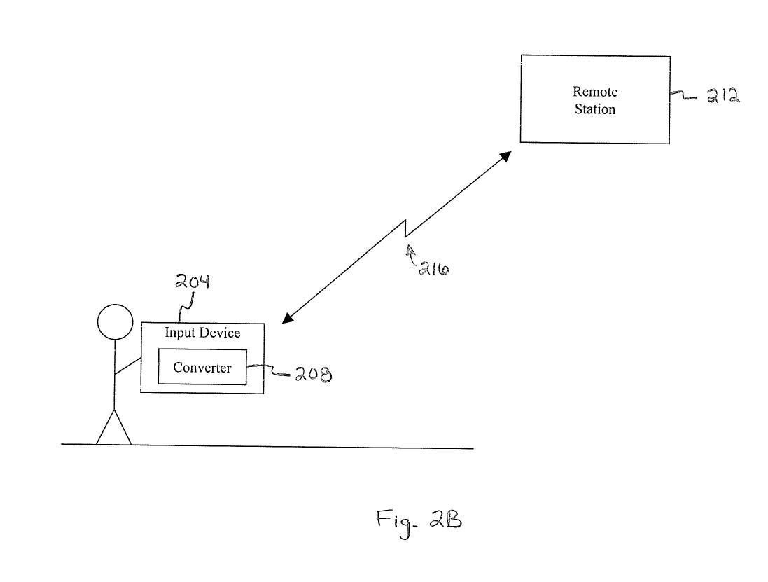

With reference now to FIGS. 2A and 2B, a system for controlling a remote station 212 with an input device 204 will be described in accordance with embodiments of the present invention. In accordance with the embodiment depicted in FIG. 2A, a converter 208 is provided separate from the input device 204. The converter 208 is used to convert signals 214 received from the input device 204 to output signals 216 suitable for use in controlling various parameters of the remote station 212.

In accordance with one embodiment, the input device 204 comprises a Human-Interface Device (HID) that is adapted to transmit digital control signals. For example, the input device 204 receives human input from one or more selectors provided on the input device 204 and generates a first control signal 214. In one embodiment, the first control signal 214 may comprise a binary control signal. The input device 204 may be characterized by its ease of human use in conveying control signals. The input device 204 may be similar to gamepads or controllers typically used in connection with controlling and playing video games either on a computer or dedicated game console.

In accordance with one embodiment of the present invention, in input device 204 may comprise an HID device from Logitech that can be connected to the converter 208 via a USB port. Examples of such devices produced by Logitech include the following: Logitech Cordless Rumblepad 2 Gamepad; Logitech Rumblepad 2 Vibration feedback Gamepad; Logitech Dual Action Gamepad; Logitech Precision 2 Gamepad; Logitech 3D Pro Joystick; Logitech Freedom 2.4 Cordless Joystick; Logitech Extreme 3D Pro Joystick; and Logitech Attack 3 Joystick. It should be noted, however, that embodiments of the present invention are not limited to using Logitech HID's as an input device 204. Rather, any manufactures HID's could be used with correct firmware containing a suitable drive code. The drive code for the HID would then be downloaded to the converter 208 in order for the converter 208 to understand how to convert the input signal 214 into a suitable output signal 216.

The converter 208 is characterized by the ability to properly convert the input signal 214 into an output signal 216 that can be decoded and utilized by the remote station 212. In one embodiment, the converter 208 communicates with the remote station 212 wirelessly, although wired communications may also be supported. The remote station 212 may be limited in that it can only decode signals having data encoded thereon in a certain way. In order to facilitate the use of any type of input device 204 for controlling the remote station 212, the converter 208 alters the data-encoding format of the first signal 214 to a second data-encoding format that can be understood by the remote station 212.

In accordance with embodiments of the present invention, the remote station 212 may comprise one or a number of remotely controlled communication devices. In one embodiment, the remote station 212 comprises a camera that is used for the surveillance of a given area. The combination of the input device 204 and converter 208 provide control signals 216 to the remote station 212 for controlling various parameters of the communication devices. For instance, the pan, tilt, zoom, focus, day/night mode selection, recording controls, power controls, time stamp controls, communication link control, audio selection, and audio mixing of a given camera may be controlled with the signals 216. Alternatively, the remote station 212 may comprise a plurality of cameras or other communication devices in which case the selection of an active camera among the plurality of cameras may be controlled by the input device 204. In accordance with other embodiments of the present invention, the remote station 212 may comprise a robot having a number of servomotors or electromechanical transducers that are controllable by control signals 216. In still other embodiments, the remote station 212 may comprise a phone that can be remotely dialed via the input device 204.

FIG. 2B, depicts an embodiment where the converter 208 is provided internally to the input device 204. The input device 204 receives control instructions from a human user which are automatically converted by the converter 208 into output signals 216. Data is encoded on the output signals 216 such that the remote station 212 can properly decode the signals and determine what control instructions have been requested. The elements provided in a converter 208 that is included in the input device 204 may be similar to the elements of a converter 208 that is separate from the input device 204. However, some elements may not be required when the converter 208 is provided internally to the input device 204 such as, for example, an input port. Rather, the converter 208 may be supplied input data directly from the controls of the input device 204.

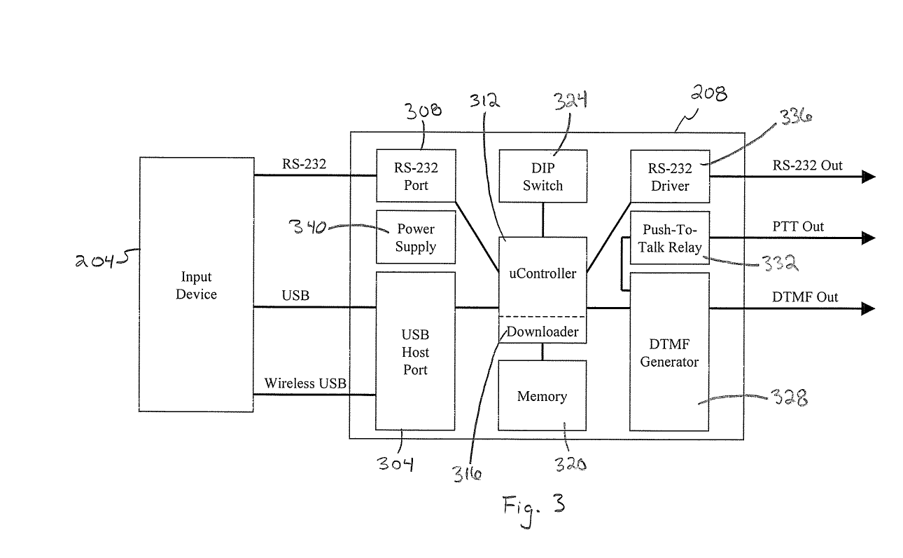

With reference now to FIG. 3, an exemplary converter 208 will be described in accordance with at least some embodiments of the present invention. The converter 208 may be adapted to receive a number of different inputs having different signal characteristics from the input device 204. Examples of the types of signals that may be conveyed from the input device 204 to the converter 208 include digital or analog signals. In accordance with one embodiment of the present invention, the converter 208 may include a USB host 304 for receiving serial data from the input device 204.

The USB port 304 typically supports three data rates (low, full, and hi-speed), though a low speed rate of up to 1.5 Mbit/s is generally used for input devices 204 such as an HID. One example of a USB host 304 is a host controller Cypress SL811HS. The USB standard uses the Non-Return to Zero, Inverted (NRZI) system to encode data, and uses bit stuffing for logical one transmission five bits long. NRZI is a method of mapping a binary signal to a physical signal for transmission over some transmission medium. A two level NRZI signal has a transition at a clock boundary if the bit being transmitted is a logical one, and does not have a transition if the bit being transmitted is a logical zero. In accordance with another embodiment of the present invention, signals received at the USB host 304 (e.g., wired and/or wireless USB signals) may be encoded using a Return-To-Zero, Inverted (RZI) mapping method. The RZI signal has a pulse shorter than a clock cycle if the binary signal is a logical zero, and no pulse if the binary signal is a logical one. The USB host 304 is operable to receive and organize data received from the input device via USB cabling.

Another input that may be provided on the controller 208 is an RS-232 input port 308. RS-232 port 308 is adapted to receive RS-232 signals from the input device 204. RS-232 is a standard for serial binary data interconnection between separate endpoints in a communication network and is commonly used in computer serial ports. In RS-232, data is sent as a time-series of bits. Both synchronous and asynchronous data transmission are supported by the standard. Typically, valid RS-232 signals are plus or minus 3 to 15 volts. The range near zero volts is typically not a valid RS-232 level. Logical ones are defined as a negative voltage, the signal condition is called marking, and has the function significance of OFF, whereas logical zeros have a positive voltage, the signal condition is spacing, and had the functional significance of ON.

The converter 208 may further comprise a microcontroller 312 for processing signals and controlling the functionality of the converter 208 in accordance with embodiments of the present invention. In general, the microcontroller 312 includes a processor subsystem capable of executing instructions for performing, implementing and or controlling various converter 208 functions. Such instructions may include instructions for implementing aspects of electronic signal conversion. Furthermore, such instructions may be stored as software and/or firmware. The processor subsystem of the microcontroller 312 may be implemented as a number of discrete components, such as one or more programmable processors in combination with one or more logic circuits. The microcontroller 312 may also include or be implemented as one or more integrated devices or processors. For example a processor subsystem may comprise a complex programmable logic device (CPLD). One example of a suitable microcontroller 316 is a MicroChip PIC18F2520.

A converter 208 also generally includes memory 320. The memory 320 is not specifically limited to memory of any particular type. For example, the memory 320 may comprise a solid-state memory device or a number of solid-state memory devices. In addition, the memory 320 may include separate non-volatile memory and volatile memory portions. Examples of volatile memory include DRAM and SDRAM. A non-volatile memory portion of the converter memory 320 may include any type of data memory device that is capable of retaining data without requiring power from an external source. Examples of non-volatile memory include, but are not limited to, compact flash or other standardized non-volatile memory devices.

The memory 320 may further provide for the storage of controller code that may be executed by the microcontroller 312 in accordance with embodiments of the present invention. The controller code stored on the memory 320 may include controller code for converting a first signal received at an input of the converter 208 to a second signal for transmission by the converter 208. In accordance with embodiments of the present invention, the first signal may have a first set of characteristics associated with a first data-encoding scheme. When the controller code is applied by the microcontroller 312 to the first signal, the first signal may be converted into a second signal having a second set of characteristics associated with a second data-encoding scheme. The data encoded on both the first and second signals is essentially the same data but the data is represented differently by each signal. Ultimately, the data may be used for controlling various parameters of the remote station 212. Accordingly, the second data-encoding scheme should be chosen such that the remote station 212 can properly decode the second signal and apply the control data. As one example, data may be transmitted by the first signal according to a binary data encoding method whereas a form of frequency modulation (e.g., frequency-shift keying, minimum frequency-shift keying, multiple frequency-shift keying, orthogonal frequency division multiplexing, and other forms of frequency modulation known in the art) may be employed to represent the data on the second signal. The converter code employed by the microcontroller 312 provides a way to convert the signal from the binary form to the frequency modulated form such that the remote station 212 can understand the output signal of the converter 208. As another example, the data may be transmitted by the first signal according to USB standards (e.g., the NRZI method of mapping a binary signal to a physical signal) and converted to the second signal in either the RS-232 format or the DTMF format.

In accordance with one embodiment of the present invention, different controller codes related to instructions for converting signals may be provided by the memory 320. A Dual In-Line Package (DIP) switch 324 may be engaged to select a particular controller code from memory 320 that is to be executed by the microcontroller 312. In this way a user may scroll through various conversion options provided by controller code stored on the memory 320 by manipulating the DIP switch 324. The DIP switch 324 is used to customize the behavior of the microcontroller 312 and adjust the characteristics of the output signal (i.e., the method in which data is encoded on the output signal). In this way, the DIP switch 324 may be employed to alter the converter 208 for use with a number of different input devices 204 and/or remote stations 212.

In the event that the appropriate converter code is not currently stored on the memory 320 to support the signal characteristic requirements of the input device 204 and/or remote station 212, additional controller code may be downloaded onto the memory 320 memory 320 via a downloader 316 provided in connection with the microcontroller 312. The downloader 316 may be employed to further enhance the adaptability of the converter 208 for use with different equipment. Once a new converter code is downloaded onto the memory 320, the DIP switch 324 may be engaged to cause the microcontroller 312 to use such converter code in converting input signals into output signals.

The converter 208 may further include a number of outputs or output generators. In accordance with at least some embodiments of the present invention, the converter 208 may include a DTMF generator 328, and RS-232 driver 336, and a push-to-talk (PTT) relay 332. Signals received by one or both of the inputs (i.e., USB host 304 and/or RS-232 port 308) are transmitted to the microcontroller 312 where there are converted and transmitted via one or more of the outputs 328, 332, or 336.

The DTMF generator 328 may be employed to generate DTMF signals for transmission to the remote station 212. In accordance with one embodiment, a Zarlink MT8888C type of DTMF generator 328 is employed. The DTMF generator 328 generates DTMF signals (i.e., electrical signals with two frequency tones) for transmission via a wired and/or wireless connection to the remote station 212.

To support DTMF control over radios and the like, embodiments of the present invention contain a PTT relay 332. Before a tone is generated, a PTT button corresponding to the relay is engaged so that the converter 208 goes into a radio type transmit mode. While in the PTT mode, the converter 208 is capable of controlling radios and other remote stations 212 comprising radio receivers. Control signals are output via the PTT relay 332 rather than the DTMF output corresponding to the DTMF generator 328.

In addition to the outputs that support frequency based control signals, the RS-232 driver 336 is used to generate and transmit RS-232 byte strings for transmission to the remote station 212. One example of an RS-232 driver that may be employed in accordance with embodiments of the invention is a Linear Technology LTC1382 RS-232 driver.

The converter 208 may further comprise a power supply 340 that provides the requisite electrical energy to various elements of the converter 208. The power supply 340 may be an internal power supply such as a battery pack or the like. Alternatively, the power supply 340 may comprise a rectifier for rendering an external power source usable by the converter 208. The power supply 340 may also be a battery pack capable of being recharged by an external power source.

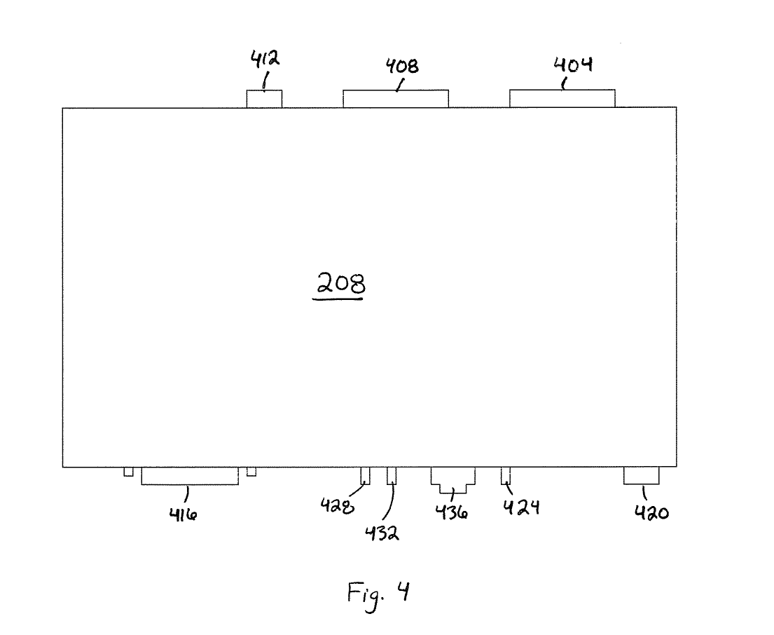

Referring now to FIG. 4, external characteristics of an exemplary converter 208 will be described in accordance with embodiments of the present invention. The converter 208 may comprise a one layer ProSeries Epoxy Brick manufactured by Video Accessories Corporation. The converter 208 comprises an input port 404 for the USB host 304. The USB port 404 may be a Type A, Type B, or other types of serial ports. Although described as a USB port 404, other types of serial connections such as eSATA and Firewire (IEEE 1394) may be employed. The USB port 404 may comprise a 4-pin connector where USB signals are transmitted on two of the four pins via a twisted pair of data cables (D+ and D−). The other pins correspond to the bus voltage and the ground.

The converter 208 can be powered ON with or without the input device 204 plugged into the USB port 404. In other words, the USB port 404 and USB host 304 supports hotplugging of the input device 204.

The converter 208 may further comprise an RS-232 input/output port 408. The operational mode of the input/output port 408 may depend upon whether the converter 208 is receiving RS-232 signals or transmitting RS-232 signals. The RS-232 port 408 may comprise a 25-pin connector where the functionality of each pin is defined by the RS-232-C standard. The standard specifies twenty different signal connections. Since some remote devices 212 and input devices 204 may use only a few signals, smaller connectors can be used. For example, a connector with eight, nine, or ten pins may be employed in accordance with embodiments of the present invention. Still other types of RS-232 ports may be used in accordance with embodiments of the present invention.

The converter 208 may further comprise a DTMF out level adjustor 412. The DTMF out level adjustor 412 sets the Vpp output level of the DTMF generator 328 by adjusting a potentiometer associated with the DTMF generator 328 output. In accordance with one embodiment, the Vpp of the DTMF generator 328 may be adjusted between about 75 mV to about 1.5V by adjusting the DTMF out level adjustor 412.

The converter 208 may additionally include a DTMF output port 416. Outputs from both the PTT relay 332 and the DTMF generator 328 may be transmitted via the DTMF output port 416. In accordance with one embodiment, the DTMF output port 416 may comprise a 9-pin sub-D connector where two pins are assigned to the transmission of DTMF signals (e.g., one pin for the DTMF tone out and another pin for the DTMF ground), two pins are assigned to the transmission of PTT control signals, and one pin is assigned to a common ground. In such an embodiment, the four unassigned pins may remain unused or may be employed to transmit additional data if required.

In accordance with one embodiment, the PTT relay 332 engages when a first input is received from the input device or when a button is pressed on the converter 208. The PTT relays 332 may remain engaged for about 3-4 seconds after all buttons or other inputs from the input device 204 have been released. With the PTT relay 332 engaged, the remote station 212 knows that it is going to receive DTMF tones. Accordingly, with the PTT relay 332 engaged the DTMF generator 328 transmits DTMF tones, which are received and demodulated by the remote station 212. The control commands are then determined by the remote station 212 and applied to the appropriate device.

A power input 420 may also be provided on the converter 208. The power input 420 may be used to supply power to the power supply 340 from an external power source, such as en electrical outlet connected to an AC power grid. The activity and connectivity of the power input 420 may be reported to a user of the converter 208 via a power indicator 424. The power indicator 424 may comprise an LED or similar type of visual indicator. The power indicator 424 may also be used to alert a user when the power supply 340 is low on power, especially in embodiments comprising an internal batter pack for a power supply 340.

In addition to the power indicator 424, the converter 208 may comprise a tone/relay indicator 428 and a USB indicator 432. The tone/relay indicator 428 may comprise an LED that is used to report the status of the PTT relay 332 and the DTMF generator 328. In one embodiment of the invention, the tone/relay indicator 428 comprise a yellow LED that is illuminated when a DTMF tone is being generated and a green LED that is illuminated when the PTT relay 332 is engaged. The USB indicator 432 may also comprise an LED or similar type of visual user interface. The USB indicator 432 may report the condition or activity of the USB connection between the input device 204 and the converter 208 and whether data is being transmitted via the USB connection. In accordance with one embodiment, the USB indicator 432 is activated when the input device 204 is detected and configured by the microcontroller 312.

The converter 208 may additionally comprise the DIP switch selector 436. The DIP switch selector 436 may be engaged by a user to activate the DIP switch 324 and scroll through the various controller codes stored on memory 320 as well as other conversion modes supported by the converter 208. The DIP switch selector 436 may also comprise an output or be in communication with another indicator of the converter 208 such that as the user scrolls through various converter 208 modes of operation, the user is presented with the mode that the converter 208 is currently in. For example, the USB indicator 432 may flash in certain patterns depending upon the operation mode selected by the user via the DIP switch selector 436.

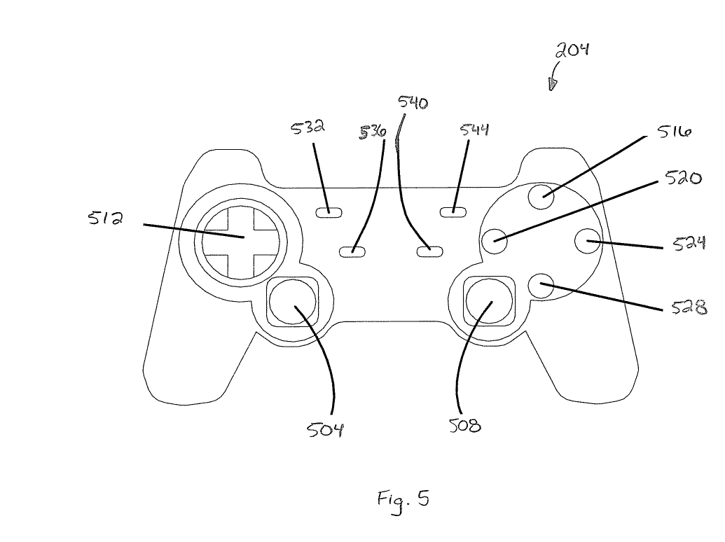

FIG. 5 depicts an input device 204 in accordance with embodiments of the present invention. The input device 204 may be similar to video game controllers, such as those produced by Logitech; however, input devices produced by other manufacturers may be employed equally as well for the input device 204. In the depicted embodiment, the input device 204 comprises a number of users inputs each associated with a different control command for the remote station 212. The association between a given input and a given control command (i.e., remote station controllable parameter) may be modified or adjusted by requesting use of a different controller code from memory 320. For example, in one operating mode a first input may be used to control the zoom of a camera, while in a second operating mode the same first input may be used to control the tilt of the camera. Different controller codes may be selected based on user preference for the use of the input device 204.

In accordance with one embodiment of the present invention, the input device 204 comprises a first analog joystick 504 and a second analog joystick 508. As an example, the analog joysticks 504, 508 are manipulated to control the pan, tilt, and zoom parameters of a camera. The first analog joystick 504 may be moved up to tilt the camera up, down to tilt the camera down, left to pan the camera left, and right to pan the camera right. The second analog joystick 408 may be moved up to zoom the camera in, down to zoom the camera out, left to focus near, and right to focus far. Each of the control directions for the analog joysticks 508 may correspond to a particular DTMF control signal, and correspondingly set of tones. To provide a few examples, the up position of the first analog joystick 504 may correspond to the “2” tone (697 Hz and 1336 Hz), the down position of the first analog joystick 504 may correspond to the “8” tone (852 Hz and 1336 Hz), the left position of the second analog joystick 508 may correspond to the “3” tone (697 Hz and 1477 Hz), and the right position of the second analog joystick 508 may correspond to the “9” tone (852 Hz and 1477 Hz). Of course, the correspondence to tones and analogy joystick 504, 508 positions may be altered depending upon user preferences.

One inventive aspect of the present invention is that the analog joysticks 504, 508 afford a user the capability of proportional control over the movements of a remote station 212 such as a camera, even though DTMF tones are being generated. If the joystick 504, 508 is pushed only partially toward one position, the parameter corresponding to that position (e.g., pan, tilt, zoom, focus, etc.) is adjusted slowly whereas if the joystick 504, 508 is pushed toward the same position completely, the parameter corresponding to that position is adjusted more quickly. Prior to the present invention, the proportional control of various parameters of the remote station 212 has not been supported. Rather, a button was pushed and the parameter was controlled incrementally based on each engagement of the button, which is less user friendly than a proportional control capability. Accordingly, a remote station 212 that previously only supported incremental control of its devices may be adapted for proportional control of the same parameters by employing embodiments of the present invention.

In addition to the analog joysticks 504, 508, the input device 204 may comprise a digital control pad 512. The digital control pad 512 may be programmed to control various other parameters of the remote station 212. Alternatively, the digital control pad 512 may not have any control signals assigned thereto if such control signals are assigned to an analog joystick 504, 508 position. Further in the alternative, the digital control pad 512 may be assigned to the same control signals as some other inputs on the input device 204.

Additional inputs that may be provided on the input device 204 include a first control button 516, a second control button 520, a third control button 524, a fourth control button 528, a fifth control button 532, a sixth control button 536, a seventh control button 540, and an eighth control button 544. Each of the control buttons may be associated and used to control various parameters of the remote station 212. For example, the first 516 through fourth 528 control buttons may be engaged to control hang up capabilities, auto-focus, night auto-focus, and back-lighting functionalities of a camera associated with the remote station 212. Additionally, some of the control buttons may be employed to set user preferences for the input device 204 itself.

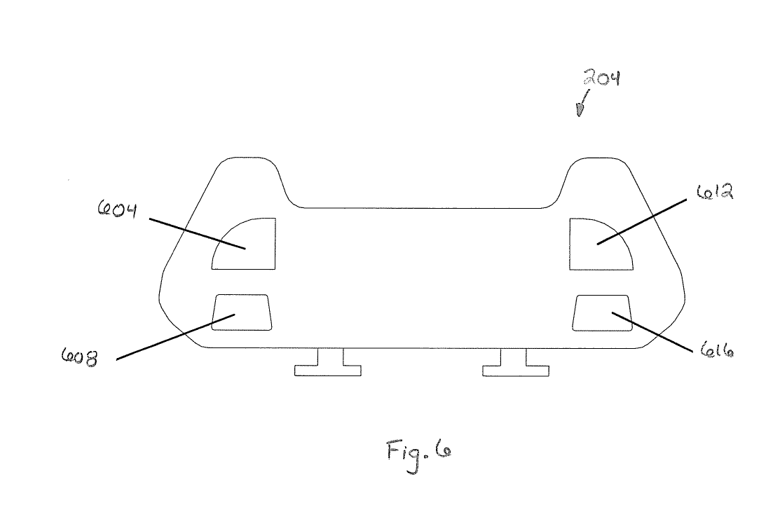

FIG. 6 depicts more inputs that may be provided on the top of an exemplary input device 204 in accordance with embodiments of the present invention. The inputs provided on top of the input device 204 may comprise a first selector 604, a second selector 608, a third selector 612, and a fourth selector 616. Each of the selectors may also be assigned to control various parameters associated with the remote station 212. Alternatively, the selectors may be used to control various output parameters of the remote station 212 such as what type of communication link should be employed to transmit images or the like from a camera associated with the remote station 212 back to the user and/or whether such images are being recorded on a DVR and/or VCR. Of course, the inputs provided on the front of the input device 204 may also be assigned to controlling such output parameters of the remote station 212. Some inputs may be assigned to various tones while others are designated for controlling operational parameters of the converter 208. For example, the input device 204 may be used to select various controller codes from memory 320 in a similar fashion to the DIP switch 324.

In accordance with at least some embodiments of the present invention, all inputs must be released before the next tone/function came be selected. Accordingly, in one embodiment, the analog joysticks 504, 508 must be returned to the near released position before the next position can be selected.

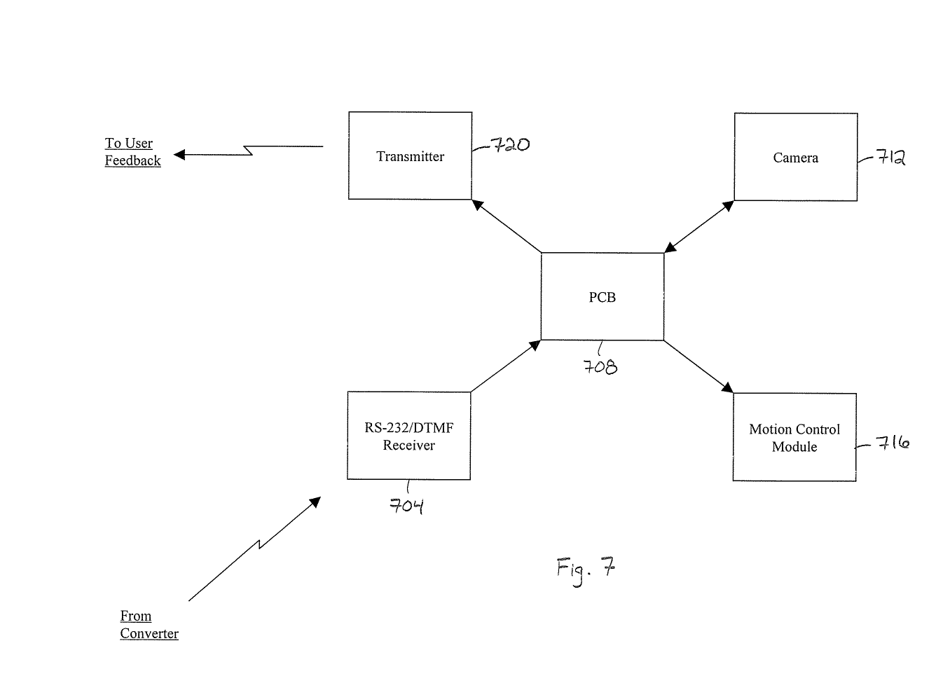

FIG. 7 depicts an exemplary remote station 212 in accordance with embodiments of the present invention. The remote station 212 may comprise an RS-232/DTMF receiver 704 connected to a Printed Circuit Board (PCB) 708 or the like. In one embodiment, the receiver 704 only supports RS-232 or DTMF signals but not both. However, in another embodiment, the receiver 704 supports the reception of both RS-232 and DTMF signals. The signals received from the converter 208 are transferred to the PCB 708 where they are decoded and/or demodulated to identify the control action(s) that are being requested by the signals. Upon identifying the appropriate control action(s) the PCB 708 transmits control signals to one or both of a camera 712 and a motion control module 716. The parameters of the camera 712 that may be controlled by the PCB 708 include, without limitation, zoom, focus, night/day mode selection, recording functions, back-lighting, night vision, etc. The parameters of the motion control module 716 that may be adjusted by the PCB 708 include, but are not limited to, pan, tilt, zoom, rotate, and so on.

Image and audio data recovered by the camera 712 are provided back to the PCB 708, which in turn provides the images and sound to a transmitted 720. The transmitter 720 is used to provide the controlling user feedback related to the remote station 212. For example, if the camera 712 is used for surveillance of a particular area, the images and audio may be provided back to the user via a wired connection, in which case the transmitted 720 corresponds to a wired communication interface such as a USB port, modem, router, or the like. The data may be communicated from the transmitted 720 back to the user via a dedicated communication network or via a distributed communication network such as the Internet. Alternatively, the images and audio may be transmitted to the user wirelessly, in which case the transmitted 720 comprises a Radio Frequency (RF) transmitter, such as a microwave transmitter, that is capable of transmitting data wirelessly across a specified distance.

In accordance with embodiments of the present invention, the remote station 212 does not necessarily comprise a camera 712, although such an embodiment is depicted in FIG. 7. Rather, other controllable elements may be provided in the remote station 212 such as servomotors and other electromechanical transducers known in the remote control arts.

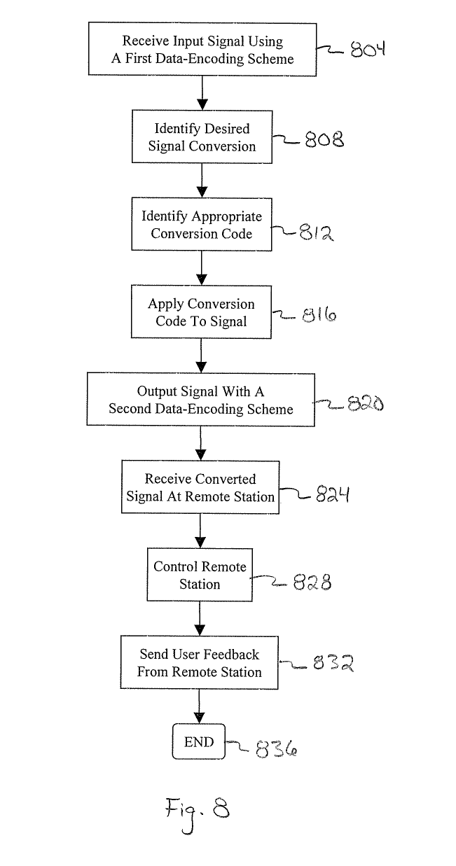

With reference now to FIG. 8, a method of converting electrical signals received from an input device 204 into output signals suitable for use by a remote station 212 will be described in accordance with embodiments of the present invention. Initially, an input signal is received at the converter 208 (step 804). The input signal uses a first data-encoding scheme. The first-data encoding scheme may correspond to a digital or binary data transmission method such as is employed by USB and RS-232. For example, if USB is employed, the binary data may be mapped to a physical signal using the NRZI encoding method. Alternatively, if RS-232 is employed, the data may be sent as a time-series of bits.

Upon receiving the input signal, the converter 208 identifies the desired signal conversion (step 808). In this step, the ultimate type of output signal is determined. For example, it is determined whether the output signal 216 will comprise RS-232 serial bits or DTMF tones. Part of this determination may be based on the state that the microcontroller 312 is currently in as controlled by the DIP switch 324. In addition to identifying the desired signal conversion, the appropriate conversion code is identified from memory 320 (step 812). Of course, if only one type of signal conversion is supported by the microcontroller 312, then the decisions in steps 808 and 812 are trivial. However, if the microcontroller 312 supports a number of different signal conversion schemes, then the appropriate conversion code should be selected based upon the type of signals that are recognized by the remote station 212.

After the conversion code has been selected from memory 320, the microcontroller 312 applies the conversion code to the received input signal (step 816). In this step, the first signal is decoded and the raw control data is extracted. Thereafter, the same control data is encoded onto a second signal according to a new data-encoding scheme. In one embodiment, the new data-encoding scheme is frequency dependent in nature, meaning that the frequency of the carrier signal may be modulated in order to transmit data via the signal. Different adaptations of frequency modulation may be employed to transfer data via the second signal, examples of which include frequency-shift keying, minimum frequency-shift keying, multiple frequency-shift keying, and orthogonal frequency division multiplexing. Alternatively, the second signal may be adapted to the RS-232 standard of data transmission.

Once the first signal has been successfully converted into the second signal, the second signal is output via the appropriate converter 208 output to the remote station 212 (step 820). The signal may be communicated to the remote station 212 via a wired or wireless medium or by combinations thereof.

The transmitted signal is then received at the remote station 212 (step 824). Upon receiving the second signal, the PCB 708 decodes the signal and identifies the requested control instructions contained in the signal. The PCB 708 then generates a corresponding control signal, for example, by changing the voltage supplied to a given motion control apparatus or engaging a switch of some sort (step 828). The remote station 212 responds to the control signals and adjusts accordingly. In one embodiment, the remote station 212 includes an audio or image capturing device such as a microphone, camera, camcorder, or the like. The captured image and/or audio data is transmitted back to the controlling user (step 832). This enables a user to perform emote surveillance with an easy to user input device 204 while controlling a remote station 212 having disparate technology from the input device 204. The data may be transmitted back to the user over a wired and/or wireless connection. The data may also be recorded locally at the remote station 212 or at a record device near the user.

After the feedback has been provided to the controlling user, the method ends until a new control instruction in the form of a signal from the input device 204 is received (step 836).

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The above-described system can be implemented on wired and/or wireless input devices, such a gamepad or other typical HID. Additionally, the systems, methods and protocols of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a input device, such as an HID, any comparable means, or the like. In general, any device capable of implementing a state machine that is in turn capable of implementing the methodology illustrated herein can be used to implement the various signal processing methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communications arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems and methods for remote device manipulation in connection with signal conversion. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving a first signal having a first set of characteristics associated with a first data-encoding scheme;
converting the first signal into a second signal having a second set of characteristics associated with a second data-encoding scheme;
transmitting the second signal to a controller of a communications device; and
decoding the second signal to identify control instructions for the communications device, wherein the controller is adapted to decode signals having the second set of characteristics and not the first set of characteristics.

2. The method of claim 1, wherein the first data-encoding scheme comprises a non-frequency dependent data-encoding scheme and the second data-encoding scheme comprises a frequency dependent data-encoding scheme.

3. The method of claim 1, wherein the first data-encoding scheme comprises a digital serial data transmission standard.

4. The method of claim 3, wherein the first data-encoding scheme comprises a non-return to zero, inverted (NRZI) data encoding scheme.

5. The method of claim 3, wherein the second data-encoding scheme comprises at least one of RS-232 byte strings and dual-tone multi-frequency (DTMF) tones.

6. The method of claim 1, wherein the first data-encoding scheme comprises RS 232 byte strings.

7. The method of claim 6, wherein the second data-encoding scheme comprises DTMF tones.

8. The method of claim 1, further comprising applying the control instructions to the communications device such that at least one operating parameter associated with the communications device is controlled.

9. The method of claim 8, wherein the communications device comprises a camera, and wherein the at least one operating parameter comprises at least one of, pan, tilt, zoom, focus, camera selection, day/night mode selection, recording controls, power controls, time stamp controls, communication link control, audio selection, and audio mixing.

10. The method of claim 1, further comprising:
determining a conversion code that will result in converting the first set of characteristics to the second set of characteristics;
uploading the conversion code; and
applying the conversion code to the first signal.

11. A device, comprising:
an input port operable to receive input signals from an input device, wherein the input signals comprise data encoded thereon according to a first data-encoding method;
a first output operable to transmit output signals to a remote communications device, wherein the output signals comprise data encoded thereon according to a second data-encoding method; and
a controller operable to convert input signals comprising data encoded thereon according to a first data-encoding method to output signals comprising data encoded thereon according to a second data-encoding method, wherein the first and second data-encoding methods are different.

12. The device of claim 11, wherein the input port comprises a Universal Serial Bus (USB) host port.

13. The device of claim 12, wherein the first output comprises at least one of a dual-tone multi-frequency (DTMF) generator and an RS-232 driver.

14. The device of claim 11, wherein the input port comprises an RS-232 port and wherein the output comprises a DTMF generator.

15. The device of claim 11, wherein the first output comprises a push-to-talk relay.

16. The device of claim 11, further comprising:
a second output operable to transmit output signals comprising data encoded thereon according to a third data-encoding method; and
a switch for selectively activating the first output and deactivating the second output at a first time and activating the second input and deactivating the first output at a second time.

17. The device of claim 16, further comprising memory for storing a separate controller code for each of at least the second and third data-encoding methods, and wherein the switch is further operable to change which controller code is applied by the controller to the input signals to convert the input signals to output signals.

18. A method, comprising:
receiving a first electrical signal comprising data, wherein the first electrical signal employs a non-frequency dependent data-encoding scheme to convey data; and
converting the first electrical signal to a second electrical signal, wherein the second electrical signal employs a frequency dependent data-encoding scheme to convey data.

19. The method of claim 18, wherein the frequency dependent data-encoding scheme comprises at least one of frequency-shift keying, minimum frequency-shift keying, multiple frequency-shift keying, and orthogonal frequency division multiplexing.

20. The method of claim 18, wherein the non-frequency dependent data-encoding scheme comprises mapping a binary signal to a physical signal.
